(19) United States
(12) Patent Application Publication
(10) Pub. No.: US 2014/0283046 A1
(43) Pub. Date: Sep. 18, 2014

(54) ANTI-MALWARE SCANNING OF DATABASE TABLES

(71) Applicant: McAfee, Inc., Sant Clara, CA (US)

(72) Inventor: Slavik Markovich, Los Altos, CA (US)

(21) Appl. No.: 13/800,706

(22) Filed: Mar. 13, 2013

(51) Int. Cl. G06F 21/56

(52) U.S. Cl. CPC G06F 21/56
USPC 726/23

(57) ABSTRACT

Technologies for determining malware may include causing a query of contents of a field of a database. The field may include a large object. The technologies may also include obtaining results of the query of the contents of the field and determining whether the results of the query of the contents of the field indicate malware.

### TECHNICAL FIELD OF THE INVENTION

Embodiments of the present invention relate generally to computer security and malware protection and, more particularly, to anti-malware scanning of database tables.

### BACKGROUND

Malware infections on computers and other electronic devices are very intrusive and hard to detect and repair. Anti-malware solutions may require matching a signature of malicious code or files against evaluated software to determine that the software is harmful to a computing system. Malware may disguise itself through the use of polymorphic programs or executables wherein malware changes itself to avoid detection by anti-malware solutions. In such case, anti-malware solutions may fail to detect new or morphed malware in a zero-day attack. Malware may include, but is not limited to, spyware, rootkits, password stealers, spam, sources of phishing attacks, sources of denial-of-service-attacks, viruses, loggers, Trojans, adware, or any other digital content that produces unwanted activity.

### BRIEF DESCRIPTION OF THE DRAWINGS

For a more complete understanding of embodiments of the present invention and its features and advantages, reference is now made to the following description, taken in conjunction with the accompanying drawings, in which:

FIG. 1 is an illustration of an example embodiment of a system for anti-malware scanning of database tables;

FIG. 2 is an illustration of example operation of a system for anti-malware scanning of database tables; and

FIG. 3 is an illustration of an example embodiment of a method for anti-malware scanning of database tables.

### DETAILED DESCRIPTION

FIG. 1 is an illustration of an example embodiment of a system 100 for anti-malware scanning of database tables. System 100 may be configured to scan, read, access, or otherwise evaluate tables, fields, or other structures within one or more databases for malware. In one embodiment, system 100 may be configured to perform such evaluation of large objects (LOBs) within such databases.

System 100 may include an electronic device 102 communicatively coupled to a database 106. Electronic device 102 may be configured to scan, read, access, or otherwise evaluate the elements of database 106. Although a single database is shown, system 100 may include and electronic device 102 may monitor any suitable number of databases. Database 106 may reside in any suitable location, including within electronic device 102, external to electronic device 102, in a server, blade, server farm, cloud computing scheme, or random array of disks (RAID) storage system. Electronic device 102 may be communicatively coupled to database 106 through a network, computer interface, bus, or any other suitable communication mechanism.

Electronic device 102 may include an anti-malware module 104 configured to evaluate the elements of a database such as database 106. Anti-malware module 104 may be communicatively coupled to database 106. Electronic device 102 may include one or more database scripts 112 configured to be used by anti-malware module 104 to traverse a database such as database 106. Furthermore, electronic device 102 may include a processor 114 coupled to a memory 116.

Anti-malware module 104 may accessible by a user 108. User 108 may include a human user or a digital entity. Anti-malware module 104 may be configured to accept inputs, parameters, or other information from user 108, and to display results to user 108. In embodiments where user 108 is a digital entity, access of anti-malware module 104 may be made by user 108 using, for example, function calls, scripts, applications, or other instructions received and executed by anti-malware module 104.

Anti-malware module 104 may be coupled to any source of anti-malware information, such as anti-malware rules, engines, blacklists, whitelists, reputation servers, or signature databases. Anti-malware module 104 may be configured to access such information sources to determine, given—for example, an observation, detected value, or other information potentially indicative of malware—whether the information is indicative of malware. Such sources of anti-malware information may be located, for example, on electronic device 102, co-resident or within anti-malware module 104, or across a network. For example, system 100 may include anti-malware engine 110.

Electronic device 102 may be implemented in any suitable manner. For example, electronic device 102 may include a mobile device, computer, server, laptop, desktop, board, or blade.

Database 106 may be implemented in any suitable manner. For example, database 106 may include any suitable combination of data structures, files, records, fields, or headers. Database 106 may include, for example, a hierarchal database, network model database, object database, relational database, data warehouse, active database, or cloud-based database. Database 106 may represent a logical organization of content. However, actual physical storage of the content of database 106 may be performed in any suitable number or kind of storage devices, media, servers, or systems. Consequently, mere direct access, and thus anti-malware scanning, of the actual physical storage underlying the database may be unuseful. The context, metadata, and organization provided by database 106 may be necessary to extract meaningful information or perform anti-malware analysis on the contents residing in the storage.

Anti-malware module 104 may be implemented in any suitable manner. For example, anti-malware module 104 may include instructions, logic, functions, libraries, shared libraries, applications, scripts, programs, executables, objects, analog circuitry, digital circuitry, or any suitable combination thereof.

Database script 112 may include, for example, formats, scripts, logic, or instructions configured to be used by anti-malware module 104 to access database 106. Database script 112 may include information for anti-malware module 104 to, for example, identify configured databases to be analyzed, provide credentials such as usernames and passwords, settings for read permissions for associated databases, identification of fields to be retrieved, host names, port identifiers, or instance names.

Processor 114 may comprise, for example, a microprocessor, microcontroller, digital signal processor (DSP), application-specific integrated circuit (ASIC), or any other digital or analog circuitry configured to interpret and/or execute program instructions and/or process data. In some embodiments, processor 114 may interpret and/or execute program instructions and/or process data stored in memory 116. Memory 116 may be configured in part or whole as application memory, system memory, or both. Memory 116 may include any system, device, or apparatus configured to hold and/or house one or more memory modules. Each memory module may include any system, device or apparatus configured to retain program instructions and/or data for a period of time (e.g., computer-readable or machine-readable storage media). Instructions, logic, or data for configuring the operation of system 100, such as configurations of components such as electronic device 102 or anti-malware module 104 may reside in memory 116 for execution by processor 114.

Processor 114 may execute one or more code instruction(s) to be executed by the one or more cores of the processor. The processor cores may follow a program sequence of instructions indicated by the code instructions. Each code instruction may be processed by one or more decoders of the processor. The decoder may generate as its output a micro operation such as a fixed-width micro operation in a predefined format, or may generate other instructions, microinstructions, or control signals which reflect the original code instruction. Processor 114 may also include register renaming logic and scheduling logic, which generally allocate resources and queue the operation corresponding to the convert instruction for execution. After completion of execution of the operations specified by the code instructions, back end logic within processor 114 may retire the instruction. In one embodiment, processor 114 may allow out of order execution but requires in order retirement of instructions. Retirement logic within processor 114 may take a variety of forms as known to those of skill in the art (e.g., re-order buffers or the like). The processor cores of processor 114 are thus transformed during execution of the code, at least in terms of the output generated by the decoder, the hardware registers and tables utilized by the register renaming logic, and any registers modified by the execution logic

Anti-malware module 104 may be configured to form a database query to determine whether database 106 includes malware and submit the query to database 106. Database 106 may be configured to execute the query and return the results requested. Database 106 may return, for example, information or a LOB. Anti-malware module 104 may be configured to evaluate the results returned from database 106 by utilization of anti-malware engine 110. Anti-malware engine 110 may determine whether the content submitted by anti-malware module 104 indicates malware through, for example, reputation analysis, heuristic analysis, or signature matching. Anti-malware engine 110 may be configured to return the malware determination to anti-malware module 104. Upon a determination that the submitted content includes or indicates malware, anti-malware module 104 may be configured to perform any suitable remedial action. For example, anti-malware module 104 may be configured to perform one or more follow-up queries to database 106 to determine additional contents of database 106 that may be associated with the content previously identified as associated with malware. Anti-malware module 104 may further present the results to user 108. In addition, anti-malware module 104 may clean database 106 of the contents associated with malware.

Database 106 may be configured to store LOBs, in addition to fields such as strings, arrays, and numbers. The size of a LOB may be sufficient such that the entire LOB may not be returned by a query, since such queries are often returned in application memory spaces. In one embodiment, a LOB may include any field, object, or file larger than eight thousand kilobytes. In another embodiment, a LOB may include any field, object, or file larger than eight thousand kilobytes. The precise categorization of a field as a LOB may depend upon the system implementation using the LOB.

A given system may apply a standard, such as one based upon accessibility, to determine whether to handle a field as a LOB. In one embodiment, a LOB may include any field, object, or file too large to be returned as a parameter in a function call or query in a given system. In another embodiment, a LOB may include any field, object, or file for which, in response to a function call or query, a reference is returned instead of the actual contents. Such a reference may include, for example, a pointer.

A LOB may include any suitable data type. In one embodiment, a LOB may include, for example, a portable data format (.PDF) file. In another embodiment, a LOB may include, for example, a word processing document. In yet another embodiment, a LOB may include, for example, a spreadsheet document.

Because the context of the LOB may be lost as the LOB is stored in on physical media underlying database 106, in one embodiment the LOB may be only available to be analyzed for malware upon retrieval from database 106. As described above, the organization of the contents of database 106 may be unascertainable, as such contents reside on physical media underlying database 106. The contents may only be coherent given the organizational structure produced by database 106. For example, the type of file of a LOB may be absent as the file may require an extension as defined by a particular operating system. The LOB may be resident on physical media not using an expected operating system able to interpret the extension, or may not include an extension accessible or interpretable on the physical media. In another example, the LOB may not be stored in contiguous spaces. Without information from database 106, it may not be possible to piece together the distinct portions of the LOB. In yet another example, the LOB may include content that may normally have a file name. However, as the LOB resides in physical media, no file name may be available. The retrieval of the LOB by database 106, as opposed to direct access of the physical media on which the LOB resides, may provide the necessary context, such as file type, access to content via pointers, an entire file, or other suitable information.

Anti-malware module 104 may be configured to receive an indication of am LOB from database 106, which may be used by module 104 to determine whether the LOB is associated with malware. As described above, direct access of a LOB through its physical media may not provide sufficient information by which the LOB may be analyzed. Thus, analyzing a LOB may require access through a query of database 106. Consequently, in one embodiment, pro-active analysis of the various portions of database 106 may be conducted. In such an embodiment, the LOB fields of a database may be systematically analyzed. In another embodiment, on-demand analysis of a LOB as a client of database 106 attempts to access the LOB may be conducted. However, such on-demand analysis may be cost prohibitive or time intensive, as a client of database 106 may expect or require fast retrieval.

Anti-malware module 104 may be configured, for each database to be analyzed, to connect to the database and to query the database metadata and retrieve all LOB columns. For each such LOB column, anti-malware module 104 may be configured to, for all rows, retrieve the contents of the field. Anti-malware module 104 may be configured to analyze the content to determine the type of LOB. Such analysis may include, for example, determining whether the content conforms to known types of content, or by reading header information or preliminary information known as magic numbers. The magic numbers may be interpreted to determine the type of content. If necessary, anti-malware module 104 may be configured to decode content such as those using encoding schemas such as base64. If the contents are of a type that may be determined, anti-malware module 104 may be configured to pass the contents, or an indication thereof, to anti-malware engine 110 as described above.

If anti-malware engine 110 determines that the content is associated with malware, anti-malware module 104 may be configured to identify the row identification of the contents.

In one embodiment, anti-malware module 104 may be configured to initially retrieve only a selective subset of the contents. Such a subset may be used to determine the type of contents. If the file type or content type of the contents can be determined, the anti-malware module 104 may be configured to determine whether such a type can be analyzed. If the file type or content type of the contents can be analyzed, then anti-malware module 104 may be configured to retrieve additional portions of the content. If the file type or content type of the contents cannot be determined, or if the file type or content type of the contents can be determined but not analyzed for malware, then the additional content may not be retrieved. In one embodiment, some file types or content types may not pose risks associated with malware. Such file types may include types that cannot execute code. Consequently, anti-malware module 104 may be configured to cease analysis on such files. Such ceasing may include, for example, ceasing to download or access additional portions of the content or not sending the content to anti-malware engine 110.

In order to mitigate the effects of anti-malware analysis upon performance of database 106, anti-malware module 104 may throttle requests to limit the performance impact upon database 106. Furthermore, anti-malware module 104 may employ multi-threading to prevent performance blocking.

Some content retrieved from database 106 may be password-protected or otherwise encrypted. Anti-malware module 104 may be configured to employ any suitable method, such as brute-force password cracking, to decrypt the content so as to analyze the content for malware.

In one embodiment, anti-malware module 104 may be configured to perform one or more follow-up queries of database 106 if it is determined that a given entry is associated with malware. Such queries may be defined by database script 112. Any suitable number, combination or kind of queries may be performed. For example, anti-malware module 104 may query database 106 to determine other fields associated with the same row. In another example, anti-malware module 104 may query database 106 to determine what entity created or modified the field with the content associated with malware. In yet another example, anti-malware module 104 may access other rows linked to the row yielding the malware determination.

FIG. 2 is an illustration of example operation of system 100. At (1) anti-malware module 104 may query database 106 for a given row i. Access of a given row of database may be made through its index 206. Anti-malware module 104 may query database 106 to determine how its indices are arranged such that anti-malware module 104 may traverse database 106 row-by-row, or otherwise exhaustively.

Database 106 may include one or more edit fields 204 configured to provide information about the history of the row. Edit fields 204 may include, for example, an identification of an associated user 214, which may include a human user, process, system, or other entity; an identification of one or more edit dates 216; and links or other references to one or more previous versions 218. Each of edit fields 204 may be returned upon a positive identification of malware to a user of system 100 or otherwise used by anti-malware module 104 to determine additional rows to evaluate for malware.

Furthermore, database 106 may include one or more fields 202 that may include LOBs. Fields 202 may include any suitable combination or kind of LOBs. For example, database 106 may include one or more fields 208 including LOBs in binary or numeric data format. In another example, database 106 may include one or more fields 210 including LOBs in a character string format. In yet another example, database 106 may include one or more fields 212 including LOBs in a struct format, which may include a data structure that is itself a LOB or is a data structure including a LOB. Such data structures may include, for example, arrays, records, or structures including a mixture of multiple kinds of data structures.

Each row may thus store one or more LOB entries 220 in database 106. Queries of database 106 may select one or more of such LOB entries 220.

At (2), a LOB entry 222 may be returned from the designated row. If a queried row includes more than one LOB, multiple such LOB entries 222 may be returned. LOB entry 222 may include a subset of information such as type information 224 and a subset of information with the actual content 226. Type information 224 may be used by anti-malware module 104 to determine the type of content 226. In one embodiment, only type information 224 of LOB entry 222 may be initially returned. In such embodiment, if type information 224 can be determined, and the type of content 226 is prone to malware infection, the remaining content 226 may be queried from database 106. If type information 224 cannot be determined, or if the type of content 226 is not prone to malware infection, the remaining content 226 might not be queried and anti-malware engine 104 may query a subsequent row of information from database 106.

At (3), indications of the content may be sent to anti-malware engine 110 for a determination about the malicious nature of the content. Such indications may include, for example, the content itself, heuristic information about the content, a hash of the content, or a digital signature of the content.

At (4), anti-malware engine 110 may return a malware determination about the content. If such a determination indicates malware, then at (5) anti-malware module 104 may perform a follow-up query. Such a query may include, for example, retrieval of edit fields 204. The contents of edit fields for the row may be returned at (6).

Anti-mare module 104 may repeat such operation for subsequent rows of information. Furthermore, anti-malware module 104 may employ such operation on-demand as other entities attempt to access the contents of database 106.

FIG. 3 is an illustration of an example embodiment of a method 300 for anti-malware scanning of database tables. Method 300 may be initiated by any suitable criteria. For example, if one or more databases are to be evaluated for malware, at 305, one or more such databases may be identified. For each such database, 310, malware analysis may be performed.

At 310, rows to be analyzed in a given database may be determined. For each row determined within the given database, 315-365 may be performed. At 315, the database may be queried to determine the fields available for analysis. Such a query may include, for example, a determination of whether any LOB fields are contained within such a database. For each such field, malware analysis may be performed.

At 320, a query may be formulated for a given field, such as a LOB field. The query may be formulated for a given row i. In one embodiment, the query may be made for type information for the field. In another embodiment, the query may be made for the entire field, as described in conjunction with 335. The type information may include, for example, header information, preliminary bytes, or magic numbers.

At 325, the type of content may be determined. Such a determination may be based on, for example, the type information queried in 320. The determination may be by analyzing the type information against known structures for content.

At 330, it may be determined whether the type of content is prone to malware infections. Such a determination may be made based on the type determined in 325. If the type of content is not prone to malware, method 300 may proceed to 360. If the type of content is prone to malware, method 300 may proceed to 335.

At 335, a query for the entire LOB entry, if not already retrieved, may be formulated and submitted to a database. At 340, the LOB entry may be received, and in 345, it may be determined whether the LOB entry is associated with malware.

Such a determination may be made, for example, based upon comparing a signature or hash of the LOB with known malware or safe entities, heuristic or behavioral information about the LOB, or upon reputation analysis about the LOB. If the LOB is not associated with malware, method 300 may proceed to 360. If the LOB is associated with malware, method 300 may proceed to 350.

At 350, a query for additional information about the row from which the LOB was received may be formed. Such a query may seek, for example, other fields within the row, other rows linked to the row, or edit information. At 355, corrective action may be taken upon the row. Such corrective action may include, for example, cleaning the infected fields; quarantining the row; quarantining additional, related rows; alerting a user; or reporting the detection and associated information.

At 360, it may be determined whether any additional LOB columns within the row exist and have not been evaluated for malware. If so, method 300 may return to 320. If not, method 300 may proceed to 365.

At 365, it may be determined whether any additional rows within the database exist and have not been evaluated for malware. If so, method 300 may return to 320. If not, method 300 may proceed to 370.

At 370, it may be determined whether any additional databases identified in 305 have not been evaluated for malware. If so, method 300 may return to 310. If not, method 300 may terminate.

In one embodiment, a query may be made by a process that is to be monitored for access of malware. Such a process may be made by a client electronic device that may be monitored for protection from malware. The query may be intercepted and method 300 performed upon the target row of fields before results of the query are allowed to be returned to the client. In such an embodiment, selective elements of method 300 may be executed. For example, for the monitored query, method 300 may be initialized and executed at 325 and terminate at 355.

Method 300 may be implemented using the system of FIGS. 1-2 or any other system operable to implement method 300. As such, the initialization point selected for method 300 and the order of the elements comprising method 300 may depend on the implementation chosen. In some embodiments, some elements may be optionally omitted, repeated, or combined. In certain embodiments, method 300 may be implemented partially or fully in software embodied in machine-readable media.

For the purposes of this disclosure, machine-readable or computer-readable may include any instrumentality or aggregation of instrumentalities that may retain data and/or instructions for a period of time. Machine-readable or computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other electromagnetic and/or optical carriers; and/or any combination of the foregoing. The following examples pertain to further embodiments. Specifics in the examples may be used anywhere in one or more embodiments described above or herein.

The following examples pertain to further embodiments.

A method for preventing malware attacks may be performed on an electronic device. Any suitable portions or aspects of the method may be implemented in at least one computer-readable storage medium or in a system, as described below. The method may include any suitable combination of elements, actions, or features. For example, the method may include causing a query of contents of a first field of a database. The first field may include a LOB. The method may also include obtaining results of the query of the contents of the first field and determining whether the results of the query of the contents of the first field indicate malware. The method may further include causing a follow-up query of the database for additional information associated with the first field based upon whether the results of the query of the contents of the first field indicate malware. In addition, the method may also include causing an initial query of the field for a portion of the contents of a second field, obtaining the results, determining a type of the contents of the second field based upon the results, and determining whether the type of the contents of the second field are prone to malware. Based upon whether the type of the contents of the second field is prone to malware, the method may include causing a query of the contents of a second field of a database. The LOB may include content greater in size than eight kilobytes. Based upon the results of the query of the contents of the first field, the method may include causing a query of contents of a second field of the database, wherein the second field is associated with the first field. Furthermore, the method may include intercepting the query of contents of the first field of the database from a client and, based upon the results of the query of the contents of the first field, blocking a return of the contents to the client.

At least one computer-readable storage medium may include computer-executable instructions carried on the computer-readable medium. Various aspects of the medium may implement any suitable portions or combinations of the method described above or the system described below. The instructions may be readable by a processor. The instructions, when read and executed, may cause the processor to cause a query of contents of a first field of a database. The first field may include a LOB. The instructions may also cause the processor to obtain results of the query of the contents of the first field and determine whether the results of the query of the contents of the first field indicate malware. The instructions may further cause the processor to cause a follow-up query of the database for additional information associated with the first field based upon whether the results of the query of the contents of the first field indicate malware. In addition, the instructions may also cause the processor to cause an initial query of the field for a portion of the contents of a second field, obtain the results, determine a type of the contents of the second field based upon the results, and determine whether the type of the contents of the second field are prone to malware. Based upon whether the type of the contents of the second field is prone to malware, the instructions may also cause the processor to cause a query of the contents of a second field of a database. The LOB may include content greater in size than eight kilobytes. Based upon the results of the query of the contents of the first field, the instructions may also cause the processor to cause a query of contents of a second field of the database, wherein the second field is associated with the first field. Furthermore, the instructions may also cause the processor to intercept the query of contents of the first field of the database from a client and, based upon the results of the query of the contents of the first field, block a return of the contents to the client.

A system may be configured for preventing malware attacks. The system may implement any suitable portions or combinations of the method or the at least one computer-readable storage medium as described above. The system may include a processor coupled to a computer-readable medium. The system may further include an anti-malware module including computer-executable instructions carried on the computer-readable medium. The instructions may be readable by a processor. The anti-malware module may cause a query of contents of a first field of a database. The first field may include a LOB. The instructions may also cause the processor to obtain results of the query of the contents of the first field and determine whether the results of the query of the contents of the first field indicate malware. The instructions may further cause the processor to cause a follow-up query of the database for additional information associated with the first field based upon whether the results of the query of the contents of the first field indicate malware. In addition, the instructions may also cause the processor to cause an initial query of the field for a portion of the contents of a second field, obtain the results, determine a type of the contents of the second field based upon the results, and determine whether the type of the contents of the second field are prone to malware. Based upon whether the type of the contents of the second field is prone to malware, the instructions may also cause the processor to cause a query of the contents of a second field of a database. The LOB may include content greater in size than eight kilobytes. Based upon the results of the query of the contents of the first field, the instructions may also cause the processor to cause a query of contents of a second field of the database, wherein the second field is associated with the first field. Furthermore, the instructions may also cause the processor to intercept the query of contents of the first field of the database from a client and, based upon the results of the query of the contents of the first field, block a return of the contents to the client.

A system for preventing malware attacks may be performed on an electronic device. The system may include any suitable combination of elements, actions, or features. For example, the system may include means for causing a query of contents of a first field of a database. The first field may include a LOB. The system may also include means for obtaining results of the query of the contents of the first field and determining whether the results of the query of the contents of the first field indicate malware. The system may further include means for causing a follow-up query of the database for additional information associated with the first field based upon whether the results of the query of the contents of the first field indicate malware. In addition, the system may also include means for causing an initial query of the field for a portion of the contents of a second field, obtaining the results, determining a type of the contents of the second field based upon the results, and determining whether the type of the contents of the second field are prone to malware. Based upon whether the type of the contents of the second field is prone to malware, the system may include means for causing a query of the contents of a second field of a database. The LOB may include content greater in size than eight kilobytes. Based upon the results of the query of the contents of the first field, the system may include means for causing a query of contents of a second field of the database, wherein the second field is associated with the first field. Furthermore, the system may include means for intercepting the query of contents of the first field of the database from a client and, based upon the results of the query of the contents of the first field, blocking a return of the contents to the client.

Specifics in the examples above may be used anywhere in one or more embodiments.

Although the present disclosure has been described in detail, it should be understood that various changes, substitutions, and alterations can be made hereto without departing from the spirit and the scope of the disclosure as defined by the appended claims.

What is claimed is:

1. A system for determining malware, comprising:
a processor coupled to a computer-readable medium; and
an anti-malware module comprising instructions carried on the computer-readable medium, the instructions readable and executable by the processor, the anti-malware module communicatively coupled to a database and configured to:
cause a query of contents of a first field of the database, wherein the first field includes a large object (LOB);
obtain results of the query of the contents of the first field from the database; and
determine whether the results of the query of the contents of the first field indicate malware.

2. The system of claim 1, wherein the anti-malware module is further configured to cause the processor to cause a follow-up query of the database for additional information associated with the first field based upon whether the results of the query of the contents of the first field indicate malware.

3. The system of claim 1, wherein the anti-malware module is further configured to:
cause an initial query of contents of a second field of the database;
obtain results of the initial query from the database;
determine a type of the contents of the second field based upon the results of the initial query;
determine whether the type of the contents of the second field are prone to malware; and
based upon whether the type of the contents of the second field are prone to malware, cause a query of the contents of a second field of a database.

4. The system of claim 1, wherein the LOB includes content greater in size than eight kilobytes.

5. The system of claim 1, wherein the anti-malware module is further configured to:
based upon the results of the query of the contents of the first field, cause a query of contents of a second field of the database, wherein the second field is associated with the first field.

6. The system of claim 1, wherein the anti-malware module is further configured to:
intercept the query of contents of the first field of the database from a client;
based upon the results of the query of the contents of the first field, block a return of the contents to the client.

7. A method for determining malware, comprising:
causing a query of contents of a first field of a database, wherein the first field includes a large object (LOB);
obtaining results of the query of the contents of the first field; and
determining whether the results of the query of the contents of the first field indicate malware.

8. The method of claim 7, further comprising causing a follow-up query of the database for additional information associated with the first field based upon whether the results of the query of the contents of the first field indicate malware.

9. The method of claim 7, further comprising:
causing an initial query of contents of a second field;
obtaining results of the initial query;
determining a type of the contents of the second field based upon the results of the initial query;
determining whether the type of the contents of the second field are prone to malware; and
based upon whether the type of the contents of the second field are prone to malware, causing a query of the contents of a second field of a database.

10. The method of claim 7, wherein the LOB includes content greater in size than eight kilobytes.

11. The method of claim 7, further comprising:
based upon the results of the query of the contents of the first field, causing a query of contents of a second field of the database, wherein the second field is associated with the first field.

12. The method of claim 7, further comprising:
intercepting the query of contents of the first field of the database from a client;
based upon the results of the query of the contents of the first field, blocking a return of the contents to the client.

13. At least one computer-readable storage medium, comprising computer-executable instructions carried on the computer-readable medium, the instructions readable by a processor, the instructions, when read and executed, for causing the processor to:
cause a query of contents of a first field of a database, wherein the first field includes a large object (LOB);
obtain results of the query of the contents of the first field; and
determine whether the results of the query of the contents of the first field indicate malware.

14. The medium of claim 13, wherein the medium further comprises instructions for causing the processor to cause a follow-up query of the database for additional information associated with the first field based upon whether the results of the query of the contents of the first field indicate malware.

15. The medium of claim 13, wherein the medium further comprises instructions for causing the processor to:
cause an initial query of contents of a second field;
obtain results of the initial query;
determine a type of the contents of the second field based upon the results of the initial query;
determine whether the type of the contents of the second field are prone to malware; and
based upon whether the type of the contents of the second field are prone to malware, cause a query of the contents of a second field of a database.

16. The medium of claim 13, wherein the LOB includes content greater in size than eight kilobytes.

17. The medium of claim 13, wherein the medium further comprises instructions for causing the processor to:
based upon the results of the query of the contents of the first field, cause a query of contents of a second field of the database, wherein the second field is associated with the first field.

18. The medium of claim 13, wherein the medium further comprises instructions for causing the processor to:
intercept the query of contents of the first field of the database from a client;
based upon the results of the query of the contents of the first field, block a return of the contents to the client.
